(19) United States
(12) Patent Application Publication
(10) Pub. No.: US 2025/0280344 A1
(43) Pub. Date: Sep. 4, 2025

(54) COMMUNICATION METHOD AND APPARATUS, ELECTRONIC DEVICE, AND READABLE STORAGE MEDIUM

(71) Applicant: VIVO MOBILE COMMUNICATION CO., LTD., Dongguan (CN)

(72) Inventor: Daquan GUO, Dongguan (CN)

(73) Assignee: VIVO MOBILE COMMUNICATION CO., LTD., Dongguan (CN)

(21) Appl. No.: 19/212,844

(22) Filed: May 20, 2025

Related U.S. Application Data
(63) Continuation of application No. PCT/CN2023/131949, filed on Nov. 16, 2023.

(30) Foreign Application Priority Data
Nov. 23, 2022 (CN) 202211472069.5

(51) Int. Cl. H04W 36/14; H04W 36/30

(52) U.S. Cl. CPC H04W 36/14; H04W 36/305

(57) ABSTRACT

A communication method and apparatus, an electronic device, and a readable storage medium are provided. The communication method includes: communicating, by a communication apparatus, with a first Wireless Fidelity (Wi-Fi) network over a first communication link by using a first Internet Protocol (IP) address and a first Media Access Control (MAC) address, and communicating with a second Wi-Fi network over a second communication link by using a second IP address and a second MAC address; and when a data packet of a target IP address fails to be transmitted over a first target communication link and that the first IP address and the second IP address meet a preset condition, mapping the target IP address to a target MAC address, and migrating the data packet of the target IP address to a second target communication link for transmission.

### CROSS-REFERENCE TO RELATED APPLICATIONS

This application is a continuation of International Application No. PCT/CN2023/131949, filed Nov. 16, 2023, which claims priority to Chinese Patent Application No. 202211472069.5, filed Nov. 23, 2022. The entire contents of each of the above-referenced applications are expressly incorporated herein by reference.

### TECHNICAL FIELD

This application pertains to the field of communication technologies, and specifically relates to a communication method and apparatus, an electronic device, and a readable storage medium.

### BACKGROUND

Thanks to mobility and convenience of wireless networks, the wireless networks have increasingly become an indispensable part of people's lives. However, a problem that data cannot be transmitted over a communication link of a network in a period of time due to a network handover, a network fault, or the like also arises. For example, in a case that a device is connected to a public Wireless Fidelity (Wi-Fi) network, as the device moves, the device enters coverage areas of different Basic Service Set (BSS). In this case, a station (STA) needs to be handed over between Access Point (AP) to maintain a stable communication connection. However, during the network handover, the station is unable to transmit data in a period of time due to channel scanning, connection establishment, a Dynamic Host Configuration Protocol (DHCP) process, or other processes, resulting in a problem of low communication efficiency.

### SUMMARY

An objective of embodiments of this application is to provide a communication method and apparatus, an electronic device, and a readable storage medium.

According to a first aspect, an embodiment of this application provides a communication method. The method includes:
communicating, by a communication apparatus, with a first Wi-Fi network over a first communication link by using a first IP address and a first MAC address, and communicating with a second Wi-Fi network over a second communication link by using a second IP address and a second MAC address; and
in a case that a data packet of a target IP address fails to be transmitted over a first target communication link and that the first IP address and the second IP address meet a preset condition, mapping the target IP address to a target media access control MAC address, and migrating the data packet of the target IP address to a second target communication link for transmission, where
the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link.

According to a second aspect, an embodiment of this application provides a communication apparatus. The communication apparatus includes:
a first communication module, configured to communicate with a first Wi-Fi network over a first communication link by using a first IP address and a first MAC address, and communicate with a second Wi-Fi network over a second communication link by using a second IP address and a second MAC address; and
a first processing module, configured to: in a case that a data packet of a target IP address fails to be transmitted over a first target communication link and that the first IP address and the second IP address meet a preset condition, map the target IP address to a target media access control MAC address, and migrate the data packet of the target IP address to a second target communication link for transmission, where
the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link.

According to a third aspect, an embodiment of this application provides an electronic device. The electronic device includes a processor and a memory. The memory stores a program or instructions capable of running on the processor. When the program or instructions are executed by the processor, the steps of the communication method according to the first aspect are implemented.

According to a fourth aspect, an embodiment of this application provides a readable storage medium. The readable storage medium stores a program or instructions. When the program or instructions are executed by a processor, the steps of the communication method according to the first aspect are implemented.

According to a fifth aspect, an embodiment of this application provides a chip. The chip includes a processor and a communication interface. The communication interface is coupled to the processor. The processor is configured to run a program or instructions to implement the communication method according to the first aspect.

According to a sixth aspect, an embodiment of this application provides a computer program product. The program product is stored in a storage medium. The program product is executed by at least one processor to implement the communication method according to the first aspect.

According to a seventh aspect, an embodiment of this application provides an electronic device. The electronic device is configured to perform the steps of the communication method according to the first aspect.

In the embodiments of this application, the communication apparatus communicates with the first Wi-Fi network over the first communication link by using the first IP address and the first MAC address, and communicates with the second Wi-Fi network over the second communication link by using the second IP address and the second MAC address; and in the case that the data packet of the target IP address fails to be transmitted over the first target communication link and that the first IP address and the second IP address meet the preset condition, the communication apparatus maps the target IP address to the target media access control MAC address, and migrates the data packet of the target IP address to the second target communication link for transmission. In this way, in the case that the data packet of the target IP address fails to be transmitted over the first target communication link, the communication apparatus migrates data on the first target communication link to the second target communication link for transmission. Therefore, the communication apparatus can maintain continuous uninterrupted data communication, data transmission failure in a period of time due to a network fault, a network handover, or the like can be reduced, and communication efficiency is improved.

### BRIEF DESCRIPTION OF DRAWINGS

FIG. 1 is a schematic diagram of roaming of a device according to an embodiment of this application;

FIG. 2 is a schematic diagram of roaming of a communication apparatus in a 5G band in a dual Wi-Fi connectivity scenario according to an embodiment of this application;

FIG. 3 is a flowchart of a communication method according to an embodiment of this application;

FIG. 4 is a network topology diagram of dual Wi-Fi connectivity of a communication apparatus according to an embodiment of this application;

FIG. 5 is a flowchart of processing before a Wi-Fi network handover according to an embodiment of this application;

FIG. 6 is a schematic diagram of roaming of a communication apparatus in a dual Wi-Fi connectivity scenario according to an embodiment of this application;

FIG. 7 is a flowchart of processing during a Wi-Fi network handover according to an embodiment of this application;

FIG. 8 is a schematic diagram of successful roaming of a communication apparatus in a dual Wi-Fi connectivity scenario according to an embodiment of this application;

FIG. 9 is a flowchart of processing after a Wi-Fi network handover according to an embodiment of this application;

FIG. 10 is a schematic diagram of a structure of a communication apparatus according to an embodiment of this application;

FIG. 11 is a schematic diagram of a structure of an electronic device according to an embodiment of this application; and

FIG. 12 is a schematic diagram of a hardware structure of an electronic device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first”, “second”, and the like usually fall within one class, and a quantity of objects is not limited. For example, there may be one or more first objects. In addition, the term “and/or” in the specification and claims indicates at least one of connected objects, and the character “/” generally represents an “or” relationship between associated objects.

To make the embodiments of this application clearer, the following briefly describes related technical knowledge in this application.

A BSS is a basic service set, and generally refers to a wireless network created by a single AP.

A STA is a station, and generally refers to a terminal device such as a mobile phone in a wireless network.

An AP is an access point, and generally refers to a router device in a wireless network.

An Extended Service Set (ESS) refers to a plurality of BSSs connected in series by a backbone network or the like, and is used to extend coverage of a wireless network.

BSS transition management (BTM) is an 802.11v protocol, and is a mechanism that can be used to assist a STA in completing inter-BSS roaming.

Authentication (Auth) means that a STA needs to be authenticated before the STA can access a wireless network.

Association (Assoc) means that a STA needs to be associated before the STA can access a wireless network.

The Address Resolution Protocol (ARP) is used to complete translation of an L3 address into an L2 address, which generally refers to mapping an Internet Protocol (IP) address to a Media Access Control (MAC) address.

A socket is a port structure for network communication. It records related parameters for network communication, such as an IP address, a protocol type, and a port.

ARP probe is an ARP packet, used to detect whether a destination IP address is already in use.

Gratuitous ARP (GARP) is an ARP packet, used to broadcast a mapping relationship between a source IP address and a source MAC address.

The Internet Control Message Protocol (ICMP) may be used to detect whether a peer node is reachable in network communication.

DHCP is the Dynamic Host Configuration Protocol, used for processes such as automatically obtaining IP addresses.

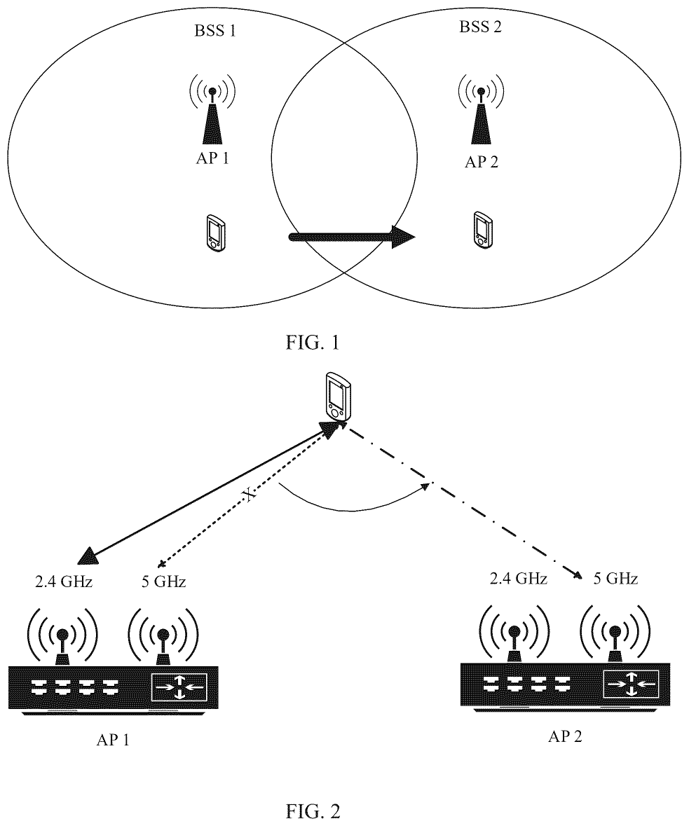

In a public Wi-Fi scenario such as a shopping mall, as a device moves, the device moves from a coverage area of BSS 1 to a coverage area of BSS 2, as shown in FIG. 1. To always maintain a stable connection, a STA needs to be handed over from AP 1 to AP 2. It should be noted that in this embodiment, the Wi-Fi network handover includes Wi-Fi network roaming.

Wi-Fi network roaming is used as an example. A condition for triggering roaming is generally that signal strength of BSS 1 is weakened to some extent. The STA actively attempts to roam to a better AP. In some embodiments, through BTM, AP 1 may actively allow the STA to roam to another AP.

After roaming is triggered, the STA needs to perform scanning to discover another associable AP around the STA. In the scanning process, the STA needs to switch to different channels to discover nearby information, and data communication with AP 1 cannot be performed on other channels than a channel on which AP 1 is located. Generally, full-channel scanning is required. However, both 2.4 GHz and 5 GHz include 13 channels. Assuming that the dwelling time per channel is 50 ms, the time within which data communication cannot be performed in this process is 25×50=1250 ms. During the scanning, the STA may return to the channel on which AP 1 is located to perform data communication for some time, but there is a packet loss, a delay, or the like that affects communication experience in the entire process.

After discovering the associable node, the STA disconnects from original AP 1 and establishes an association with new AP 2. The association process involves Auth and Assoc (or reassociation (reAssoc)). In a case of an encrypted network, a key exchange process is also required. In this wireless connection process, no data packet transmission can be performed either. This process usually takes 10 to 100 milliseconds (ms).

Afterward, the STA further needs to perform a DHCP process to obtain an IP address, and detect inter-gateway connectivity by using ARP/ICMP, before IP packet transmission can be performed. This process usually takes 10 ms to several seconds(s).

It can be learned that in the roaming process, the scanning, connection, and DHCP processes all make the STA unable to perform IP data communication, which affects user experience. In addition, due to uncertainty of wireless communication, the foregoing process may need to be repeated a plurality of times to succeed. In a public Wi-Fi scenario, it is even necessary to attempt to connect to a plurality of APs to finally complete roaming. Consequently, the time within which data communication cannot be performed is multiplied.

Embodiments of this application are based on an existing dual Wi-Fi technology and fully use advantages of multiple links. Under a condition, when a communication link used by STA 1 is unavailable for data communication in a time period, for example, when STA 1 is faulty, or when a communication apparatus encounters a handover process of STA 1, or when a communication link used by STA 1 with a communication apparatus is occupied by another service, data is migrated to a communication link used by STA 2, so that uninterrupted data communication is provided for an application.

For example, as shown in FIG. 2, in a process in which the communication apparatus roams from AP 1 to AP 2 in a 5 GHz band, the communication apparatus may continue to perform data communication with AP 1 by using 2.4 GHz, to provide an uninterrupted data communication service for the application.

In ordinary dual Wi-Fi connectivity, Wi-Fi networks in different bands are independent of each other, where one IP address is obtained separately, and usually, only one link is used for communication. If a Wi-Fi network in the 2.4 GHz band is solely used for communication during roaming in the 5 GHz band, the IP address needs to be changed, and the application needs to reestablish a socket. Application unawareness is unachievable, and some applications even inform a user of a network change, making user unawareness impossible. In this application, by simulating a connection of a static IP address, data in the 5 GHz band can be migrated to the 2.4 GHz band for transmission without changing the IP address, so that application unawareness is achievable.

A communication method provided in the embodiments of this application is hereinafter described in detail by using specific embodiments and application scenarios thereof with reference to the accompanying drawings.

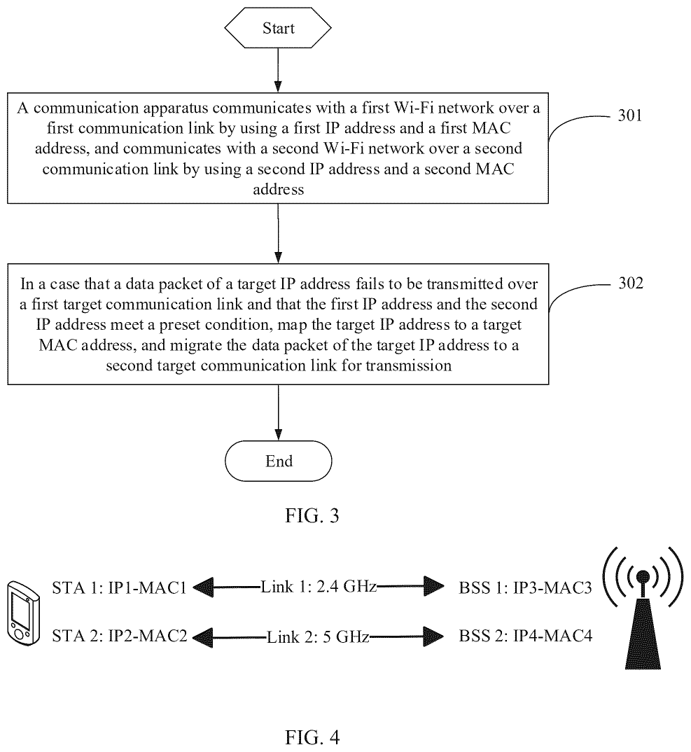

FIG. 3 is a flowchart of a communication method according to an embodiment of this application. As shown in FIG. 3, the method includes the following steps.

Step 301: A communication apparatus communicates with a first Wi-Fi network over a first communication link by using a first IP address and a first MAC address, and communicates with a second Wi-Fi network over a second communication link by using a second IP address and a second MAC address.

The communication apparatus in this embodiment of this application may be an electronic device, for example, a terminal, or may be a component such as an integrated circuit or a chip in an electronic device.

The communication apparatus supports connecting to at least two Wi-Fi networks. In this implementation, the communication apparatus is connected to the first Wi-Fi network and the second Wi-Fi network, communicates with the first Wi-Fi network over the first communication link by using the first IP address and the first MAC address, and communicates with the second Wi-Fi network over the second communication link by using the second IP address and the second MAC address. Different communication links are correspondingly connected to different Wi-Fi communication interfaces of the communication apparatus. To be specific, the first communication link is connected to a first Wi-Fi communication interface, and the second communication link is connected to a second Wi-Fi communication interface. In addition, the first Wi-Fi network and the second Wi-Fi network may be located in different bands, or may be located in a same band.

For example, the communication apparatus may separately establish connections to Wi-Fi networks in different bands, and the communication apparatus may separately establish separate communication links to the Wi-Fi networks by using different IP addresses and MAC addresses. For example, as shown in FIG. 4, the communication apparatus is used as STA 1 and STA 2 respectively connected to two Wi-Fi networks, and STA 1 and STA 2 are connected to BSS 1 and BSS 2 in 2.4 GHz and 5 GHz bands respectively. STA 1 uses IP1 and MAC1, and STA 2 uses IP2 and MAC2. At an AP, BSS 1 uses IP3 and MAC3, and BSS 2 uses IP4 and MAC4. STA 1 communicates with BSS 1 over a communication link 1, and STA 2 communicates with BSS 2 over a communication link 2. BSS 1 and BSS 2 are not necessarily a same router. If STA 1 and STA 2 are connected to two bands of a same router, IP3 and IP4 may be the same, but MAC addresses are definitely different.

Step 302: In a case that a data packet of a target IP address fails to be transmitted over a first target communication link and that the first IP address and the second IP address meet a preset condition, map the target IP address to a target MAC address, and migrate the data packet of the target IP address to a second target communication link for transmission, where the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link.

That the data packet of the target IP address fails to be transmitted over the first target communication link may include but is not limited to the following: the first target communication link is faulty, or the first target communication link is occupied, or the communication apparatus is undergoing a handover process in a target Wi-Fi network corresponding to the first target communication link, or the like.

In this embodiment of this application, in a case that the communication apparatus is connected to the first Wi-Fi network and the second Wi-Fi network, communicates with the first Wi-Fi network over the first communication link by using the first IP address and the first MAC address, and communicates with the second Wi-Fi network over the second communication link by using the second IP address and the second MAC address, the communication apparatus may detect whether IP addresses used by the communication apparatus on communication links of different Wi-Fi networks meet the preset condition, that is, detect whether the first IP address used for communication with the first Wi-Fi network over the first communication link and the second IP address used for communication with the second Wi-Fi network over the second communication link meet the preset condition, for example, may detect whether IP1 and IP2 meet the preset condition in a scenario shown in FIG. 4. The preset condition may be a condition that needs to be met to provide an uninterrupted or even application-unaware communication service for an application when the communication apparatus fails to transmit the data packet of the target IP address over the first target communication link.

In this embodiment of this application, when the data packet of the target IP address fails to be transmitted over the first target communication link, data on the first target communication link needs to be migrated to the second target communication link. Therefore, to implement a seamless handover, it is generally required that IP addresses used by the communication apparatus on different communication links should be at least in a same network segment. Therefore, the preset condition may include that the first IP address and the second IP address are in a same network segment, that is, masks of the first IP address and the second IP address are the same. In some embodiments, the preset condition may also include another IP address constraint condition based on an actual requirement. For example, corresponding public IP addresses are the same.

In some embodiments, the preset condition includes:
the first IP address and the second IP address are located in the same network segment, the target IP address is not used on the second target communication link, and public IP addresses or gateways corresponding to the first IP address and the second IP address are the same.

In the following description, it is assumed that, that the data packet of the target IP address fails to be transmitted over the first target communication link is that the communication apparatus is undergoing the handover process in the target Wi-Fi network.

To implement seamless and unnoticeable Wi-Fi network handover experience, that is, to provide uninterrupted data communication for the application during the Wi-Fi network handover and provide the user with truly seamless and unnoticeable roaming experience, the IP address needs to remain unchanged during data migration. Therefore, the IP addresses used by the communication apparatus on different communication links, that is, the first IP address and the second IP address, should both meet the following conditions:
the first IP address and the second IP address are located in the same network segment;
the public IP addresses or gateways corresponding to the first IP address and the second IP address are the same; and
an IP address used on a communication link corresponding to the Wi-Fi network in the network handover process cannot conflict with that on another communication link, that is, the IP address of the first target communication link is not used by another device on the other communication link.

The scenario shown in FIG. 4 is still used as an example. Constraint conditions for the seamless and unnoticeable network handover need to include:

(1) IP1 and IP2 need to be in the same network segment, so that data of IP2 can be migrated to link 1 for transmission or that data of IP1 can be migrated to link 2 for transmission.

(2) IP2 cannot conflict with an IP address on link 1 or IP1 cannot conflict with an IP address on link 2.

(3) IP1 and IP2 need to correspond to the same public IP address; otherwise, a communication peer on the Internet may perceive the IP address change, making application unawareness and user unawareness unachievable.

After a Wi-Fi network handover occurs, STA 2 may still communicate by using IP2, so that data can be migrated back to link 2 without changing the IP address in the entire process, or after a Wi-Fi network handover occurs, STA 1 may still communicate by using IP1, so that data can be migrated back to link 1 without changing the IP address in the entire process.

Usually, Wi-Fi network handovers occur in a same ESS, and all correspond to a same public IP address. In addition, there is generally only one DHCP server in the ESS. Therefore, all used IP addresses are in the same network segment. After a Wi-Fi network handover, an original IP address (because there is no conflict) may continue to be used. In other words, this embodiment of this application is applicable to most Wi-Fi network handover scenarios.

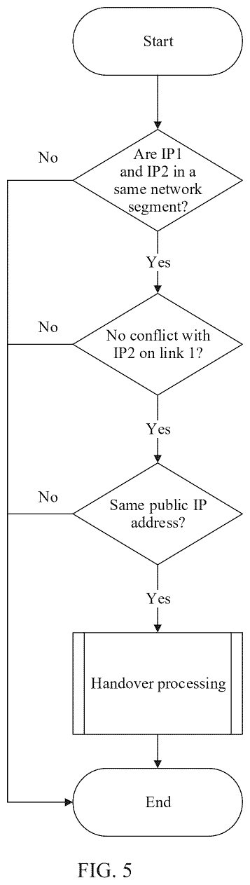

Therefore, in this implementation, detecting whether the first IP address and the second IP address meet the preset condition may include network segment detection, IP address conflict detection, and public IP address or gateway detection. The scenario shown in FIG. 4 is still used as an example. As shown in FIG. 5, the following detection procedure may be included:

### (1) Network Segment Detection

It is determined whether IP1 and IP2 are in the same network segment. If IP1 and IP2 are not in the same network segment, a seamless and unnoticeable Wi-Fi network handover cannot be performed by using the technical solution of this application.

### (2) IP Address Conflict Detection

It is determined, by using an ARP packet or an ARP probe packet, whether there is a conflict with IP2 on link 1 or a conflict with IP1 on link 2. A conflict may result in a packet reception anomaly. For example, an ARP packet or an ARP probe packet may be sent on link 1 to query whether another device in the Wi-Fi network is using IP2, or an

ARP packet or an ARP probe packet is sent on link 2 to query whether another device in the Wi-Fi network is using IP1.

### (3) Public IP Address or Gateway Detection

It is determined whether the public IP addresses or gateways corresponding to IP1 and IP2 are the same, to determine that the peer on the Internet does not perceive the IP address change.

In this way, in this implementation, it can be ensured that the device provides uninterrupted data communication for the application during the Wi-Fi network handover and provides truly seamless and unnoticeable Wi-Fi network handover experience for the user.

In some embodiments, before step 302, the method may further include:
after the communication apparatus establishes a connection to each of the first Wi-Fi network and the second Wi-Fi network, the communication apparatus detects whether the first IP address and the second IP address meet the preset condition.

In an implementation, whether the first IP address and the second IP address meet the preset condition may be detected before the case that the data packet of the target IP address fails to be transmitted over the first target communication link occurs. In other words, after the communication apparatus establishes the connection to each of the first Wi-Fi network and the second Wi-Fi network, that is, after the communication apparatus is connected to the two Wi-Fi networks, the communication apparatus detects whether the first IP address and the second IP address meet the preset condition, and does not need to wait for detection until the case that the data packet of the target IP address fails to be transmitted over the first target communication link occurs, thereby reducing a communication delay.

For example, as shown in FIG. 5, a procedure for detecting whether current dual Wi-Fi connectivity meets the constraint condition for a seamless and unnoticeable Wi-Fi network handover may be a processing procedure before the Wi-Fi network handover occurs. This process may be performed after the communication apparatus is connected to the two Wi-Fi networks and obtains the IP addresses, and does not need to be performed after the Wi-Fi network handover actually occurs, thereby reducing the delay.

In this embodiment of this application, in the case that the data packet of the target IP address fails to be transmitted over the first target communication link and that it is detected that the first IP address and the second IP address meet the preset condition, data migration may be performed on the first target communication link to ensure that data communication can also be maintained in a period in which the data packet of the target IP address cannot be transmitted over the first target communication link.

For example, assuming that, that the data packet of the target IP address fails to be transmitted over the first target communication link is that the communication apparatus is undergoing the handover process in the target Wi-Fi network, in a case that the communication apparatus is undergoing a handover process in a Wi-Fi network, the communication apparatus may map an IP address used in the Wi-Fi network to a MAC address used in another Wi-Fi network, so that a data packet of the IP address of the Wi-Fi network can be transmitted by using a communication link of the other Wi-Fi network. For example, in a case that the communication apparatus is undergoing a handover in the first Wi-Fi network, the communication apparatus needs to update a mapping relationship between an IP address and a MAC address to map the first IP address used in the first Wi-Fi network to the second MAC address corresponding to the second Wi-Fi network, and migrate a data packet of the first IP address to the second communication link corresponding to the second Wi-Fi network for transmission; or in a case that the communication apparatus is undergoing a handover process in the second Wi-Fi network, the communication apparatus needs to update a mapping relationship between an IP address and a MAC address to map the second IP address used in the second Wi-Fi network to the first MAC address corresponding to the first Wi-Fi network, and migrate a data packet of the second IP address to the first communication link corresponding to the first Wi-Fi network for transmission.

It should be noted that when the network handover of the communication apparatus is completed, the previously migrated data packet of the IP address may be migrated back to a communication link of a newly connected Wi-Fi network for transmission.

In some embodiments, step 302 includes:
the communication apparatus sends a first address mapping packet by using the second target communication link, where the first address mapping packet indicates updating of a mapping relationship between an IP address and a MAC address, so that the target IP address is mapped to the target MAC address.

For example, assuming that, that the data packet of the target IP address fails to be transmitted over the first target communication link is that the communication apparatus is undergoing the handover process in the target Wi-Fi network, to perform data migration, the communication apparatus may first prepare for migration, that is, update a mapping relationship between an IP address and a MAC address. In this implementation, an address mapping packet may be sent on another communication link that is not undergoing the handover process, to update a mapping relationship between an IP address and a MAC address, so as to update an IP address used by the Wi-Fi network that is undergoing the handover process to a MAC address used by a Wi-Fi network that is not undergoing the handover process.

In some embodiments, if the communication apparatus is undergoing the handover process in the first Wi-Fi network, the address mapping packet may be sent on the second communication link corresponding to the second Wi-Fi network, to indicate updating of the mapping relationship between the IP address and the MAC address to map the first IP address to the second MAC address; or if the communication apparatus is undergoing the handover process in the second Wi-Fi network, the address mapping packet may be sent on the first communication link corresponding to the first Wi-Fi network, to indicate updating of the mapping relationship between the IP address and the MAC address to map the second IP address to the first MAC address. The address mapping packet may be an ARP packet or a GARP packet.

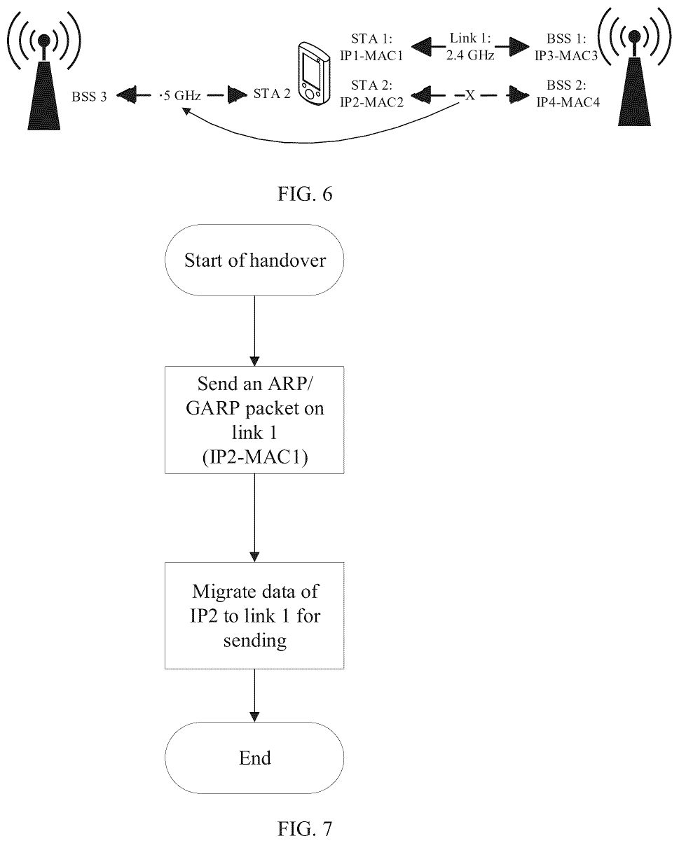

The scenario shown in FIG. 4 is still used as an example. As shown in FIG. 6, when STA 2 needs to be handed over from BSS 2 to BSS 3, STA 2 may prepare for migration, that is, send an ARP/GARP packet on link 1 to update an IP-MAC mapping of the ESS, so that IP2 is mapped to MAC1. In some embodiments, after the Wi-Fi network side such as BSS 1 receives the ARP/GARP packet on link 1, the IP-MAC mapping of the ESS may be updated to map IP2 to MAC1. In this way, a downlink packet of IP2 can be sent through BSS 1 to STA 1 with the MAC1 address over link 1. Then data migration may be performed, that is, the data packet of IP2 is sent from STA 1 over link 1. The processing procedure during the handover may be shown in FIG. 7.

In this way, in this implementation, the address mapping packet can be sent on the communication link of the Wi-Fi network that is not undergoing the handover process, to update the mapping relationship between the IP address and the MAC address, so as to prepare for data migration and ensure that data transmission continues in the network handover process.

In some embodiments, that the data packet of the target IP address fails to be transmitted over the first target communication link includes one of the following:
the first target communication link is faulty;
the first target communication link is occupied; or
the communication apparatus is undergoing the handover process in the target Wi-Fi network, where in a case that the first target communication link is the first communication link, the target Wi-Fi network is the first Wi-Fi network, or in a case that the first target communication link is the second communication link, the target Wi-Fi network is the second Wi-Fi network.

The first target communication link is occupied. For example, the first target communication link is in a single-band scanning process, and in this case, no data can be transmitted over the first target communication link; or the first target communication link is occupied by another service with a changed priority.

The communication apparatus is undergoing the handover process in the target Wi-Fi network. For example, in a case that the communication apparatus is undergoing the handover process in the first Wi-Fi network, the data packet of the first IP address cannot be transmitted over the first communication link; or in a case that the communication apparatus is undergoing the handover process in the second Wi-Fi network, the data packet of the second IP address cannot be transmitted over the second communication link.

In an implementation, in a case that a communication link connected to the communication apparatus is faulty, a data packet of an IP address corresponding to the communication link may be migrated to another communication link connected to the communication apparatus for transmission. For example, in a case that the first communication link connected to the communication apparatus is faulty, the data packet of the first IP address may be migrated to the second communication link connected to the communication apparatus for transmission; or in a case that the second communication link connected to the communication apparatus is faulty, the data packet of the second IP address may be migrated to the first communication link connected to the communication apparatus for transmission. This can ensure continuity of transmission of the data packet of the IP address corresponding to the communication link in a case that the communication link is faulty.

In another implementation, in a case that a communication link connected to the communication apparatus is occupied, a data packet of an IP address corresponding to the communication link may be migrated to another communication link connected to the communication apparatus for transmission. For example, in a case that the first communication link connected to the communication apparatus is occupied, the data packet of the first IP address may be migrated to the second communication link connected to the communication apparatus for transmission; or in a case that the second communication link connected to the communication apparatus is occupied, the data packet of the second IP address may be migrated to the first communication link connected to the communication apparatus for transmission. This can ensure continuity of transmission of the data packet of the IP address corresponding to the communication link in a case that the communication link is occupied.

In another implementation, in a case that the communication apparatus is undergoing a handover process in a Wi-Fi network, a data packet of an IP address corresponding to the Wi-Fi network may be migrated to a communication link corresponding to another Wi-Fi network connected to the communication apparatus for transmission. For example, in a case that the communication apparatus is undergoing the handover process in the first Wi-Fi network, the data packet of the first IP address may be migrated to the second communication link corresponding to the second Wi-Fi network connected to the communication apparatus for transmission; or in a case that the communication apparatus is undergoing the handover process in the second Wi-Fi network, the data packet of the second IP address may be migrated to the first communication link connected to the communication apparatus for transmission. This can ensure continuity of transmission of the data packet of the IP address corresponding to the Wi-Fi network in a case that the communication apparatus is undergoing the handover process in the Wi-Fi network.

In some embodiments, that the data packet of the target IP address fails to be transmitted over the first target communication link includes that the communication apparatus is undergoing the handover process in the target Wi-Fi network; and after step 302, the method further includes:
in a case that it is detected that the communication apparatus is handed over from the target Wi-Fi network to a third Wi-Fi network, and that a third communication link supports use of the first IP address and the first MAC address, the communication apparatus maps the target IP address back to an original MAC address, and hands over the data packet of the target IP address to the third communication link for transmission, where
the target Wi-Fi network is the first Wi-Fi network, the first target communication link is the first communication link, the target IP address is the first IP address, the original MAC address is the first MAC address, the communication apparatus transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the communication apparatus, and the first Wi-Fi communication interface is a Wi-Fi communication interface connected to the first communication link before the handover; or
the target Wi-Fi network is the second Wi-Fi network, the first target communication link is the second communication link, the target IP address is the second IP address, the original MAC address is the second MAC address, the communication apparatus transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the communication apparatus, and the second Wi-Fi communication interface is a Wi-Fi communication interface connected to the second communication link before the handover.

In this implementation, a data restoration procedure may be performed after the network handover of the communication apparatus ends, to hand over the migrated data packet to a communication link corresponding to a post-handover Wi-Fi network (the third Wi-Fi network) for transmission, to avoid long-term occupation of the other communication link. In other words, in a case that it is detected that the communication apparatus is successfully handed over from the first Wi-Fi network or the second Wi-Fi network to the third Wi-Fi network, it may be determined that the handover ends, so that data restoration can be performed.

It should be noted that, in an actual application, if a Service Set Identifier (SSID) or a password of the third Wi-Fi network is the same as that of the target Wi-Fi network, a MAC address and an IP address used by the third Wi-Fi network are often the same as those used by the target Wi-Fi network. In this case, the migrated data packet may be redirected to the post-handover Wi-Fi network. If SSIDs or passwords of the third Wi-Fi network and the target Wi-Fi network are different, MAC addresses and IP addresses used by the third Wi-Fi network and the target Wi-Fi network are often different. In this case, the migrated data packet may not be redirected to the post-handover Wi-Fi network.

In this implementation, a Wi-Fi communication interface connected to a communication link used for communication between the communication apparatus and the third Wi-Fi network is the same as a Wi-Fi communication interface connected to a communication link used for communication between the communication apparatus and the target Wi-Fi network before the handover. In addition, an IP address and a MAC address used for communication between the communication apparatus and the third Wi-Fi network are the same as an IP address and a MAC address used for communication between the communication apparatus and the target Wi-Fi network before the handover.

For example, in a case that the communication apparatus is handed over from the first Wi-Fi network to the third Wi-Fi network, the communication apparatus transitions from communicating with the first Wi-Fi network over the first communication link by using the first IP address and the first MAC address to communicating with the third Wi-Fi network over the third communication link by using the first IP address and the first MAC address, and one end of the third communication link is connected to the Wi-Fi communication interface (that is, the first Wi-Fi communication interface) connected to the first communication link before the handover; or in a case that the communication apparatus is handed over from the second Wi-Fi network to the third Wi-Fi network, the communication apparatus transitions from communicating with the second Wi-Fi network over the second communication link by using the second IP address and the second MAC address to communicating with the third Wi-Fi network over the third communication link by using the second IP address and the second MAC address, and one end of the third communication link is connected to the Wi-Fi communication interface (that is, the second Wi-Fi communication interface) connected to the second communication link before the handover.

Wi-Fi network roaming is used as an example. This implementation may include determining that roaming ends, preparing for data restoration, and performing a data restoration procedure. In other words, first, it may be detected whether the communication apparatus completes roaming. For example, an ARP/ICMP packet may be sent to detect whether inter-gateway connectivity is normal or whether an IP address of a new Wi-Fi network is obtained by performing the DHCP process again. If it is detected that inter-gateway connectivity is normal or that the IP address of the new Wi-Fi network is obtained by performing the DHCP process again, it may be determined that the newly connected Wi-Fi network can communicate, that is, the roaming ends.

Then the data restoration preparation may be performed. In other words, the mapping relationship between the IP address and the MAC address, changed in the data migration preparation, may be restored. In some embodiments, an ARP/GARP packet may be sent to indicate updating of the mapping relationship between the IP address and the MAC address, to map the IP address used by the roaming Wi-Fi network back to the original MAC address. For example, if the first IP address is previously mapped to the second MAC address, the data restoration preparation may map the first IP address back to the first MAC address; or if the second IP address is previously mapped to the first MAC address, the data restoration preparation may map the second IP address back to the second MAC address.

Finally, data restoration may be performed, that is, data migration is canceled, and the previously migrated data packet of the IP address is handed over to the third communication link for transmission. For example, if the data packet of the first IP address is previously migrated to the second communication link for transmission, the data packet of the first IP address may be transmitted over the third communication link after the data restoration; or if the data packet of the second IP address is previously migrated to the first communication link for transmission, the data packet of the second IP address may be transmitted over the third communication link after the data restoration.

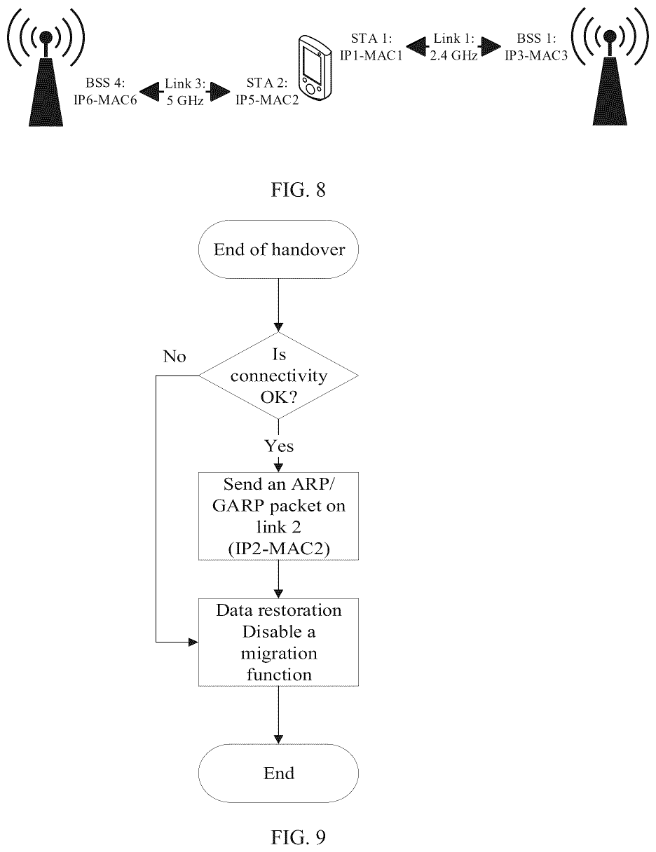

The scenario shown in FIG. 4 is still used as an example. As shown in FIG. 8, after STA 2 successfully roams from BSS 2 to BSS 4, that is, after it is determined that BSS 4 newly connected to STA 2 can communicate after the roaming ends, data restoration may be performed, and data of IP2 of STA 2 is redirected to link 3 for transmission. As shown in FIG. 9, processing after the roaming may include the following procedure:

### (1) Determining That the Roaming Ends

ARP/ICMP is used to detect that inter-gateway connectivity is normal or that an IP address is obtained by performing the DHCP again. In this case, it is determined that the roaming ends.

### (2) Preparing for Data Restoration

After ESS roaming, IP addresses usually remain unchanged. Therefore, IP5=IP2. An ARP/GARP packet may be sent on link 3 to update the IP-MAC mapping in the ESS, so that IP2 is mapped back to MAC2 again.

### (3) Data Restoration

Data migration is canceled, so that the data packet of IP2 is normally sent from STA 2 over link 3.

In this way, in this implementation, after the handover ends, the data packet migrated in the handover process may be handed over to the communication link corresponding to the post-handover Wi-Fi network for transmission, to avoid long-term occupation of the other communication link, so that normal data transmission of the two communication links is implemented.

In this embodiment of this application, in the handover process, continuous data communication may be maintained by migrating the data to the other link, to prevent user experience from being affected by a packet loss, a delay, a lag, or the like due to scanning, connection, the DHCP process, or other processes. In addition, in the solution of this application, the IP address remains unchanged. Therefore, application unawareness and user unawareness can be achieved in the entire process.

In this embodiment of this application, a use scenario may be extended to any scenario in which single-link communication is abnormal, such as a single-band scanning scenario, a link fault scenario, and a Wi-Fi to Wi-Fi handover scenario. After a single-link anomaly is resolved, even if the IP address changes and application unawareness is unachievable, advantages of multiple links can be used to shorten communication downtime and improve user experience.

In this embodiment of this application, the communication apparatus communicates with the first Wi-Fi network over the first communication link by using the first IP address and the first MAC address, and communicates with the second Wi-Fi network over the second communication link by using the second IP address and the second MAC address; and in the case that the data packet of the target IP address fails to be transmitted over the first target communication link and that the first IP address and the second IP address meet the preset condition, the communication apparatus maps the target IP address to the target media access control MAC address, and migrates the data packet of the target IP address to the second target communication link for transmission. In this way, in the case that the data packet of the target IP address fails to be transmitted over the first target communication link, the communication apparatus migrates data on the first target communication link to the second target communication link for transmission. Therefore, the communication apparatus can maintain continuous uninterrupted data communication, data transmission failure in a period of time due to a network fault, a network handover, or the like can be reduced, and communication efficiency is improved.

The communication method provided in this embodiment of this application may be performed by a communication apparatus. A communication apparatus provided in an embodiment of this application is described by assuming that the communication apparatus performs the communication method in this embodiment of this application.

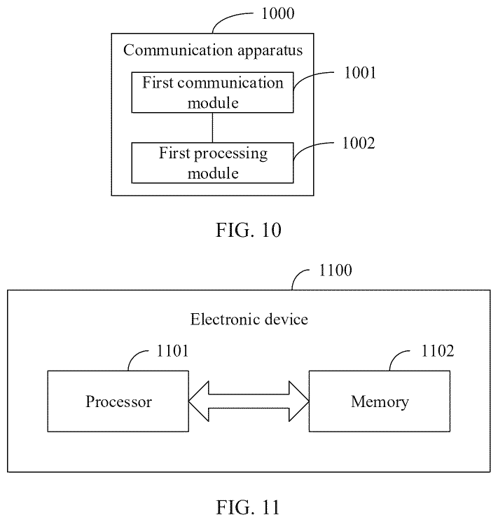

FIG. 10 is a schematic diagram of a structure of a communication apparatus according to an embodiment of this application. As shown in FIG. 10, the communication apparatus 1000 includes:
a first communication module 1001, configured to communicate with a first Wi-Fi network over a first communication link by using a first IP address and a first MAC address, and communicate with a second Wi-Fi network over a second communication link by using a second IP address and a second MAC address; and
a first processing module 1002, configured to: in a case that a data packet of a target IP address fails to be transmitted over a first target communication link and that the first IP address and the second IP address meet a preset condition, map the target IP address to a target media access control MAC address, and migrate the data packet of the target IP address to a second target communication link for transmission, where
the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link.

In some embodiments, the preset condition includes:
the first IP address and the second IP address are located in a same network segment, the target IP address is not used on the second target communication link, and public IP addresses or gateways corresponding to the first IP address and the second IP address are the same.

In some embodiments, that the data packet of the target IP address fails to be transmitted over the first target communication link includes one of the following:
the first target communication link is faulty;
the first target communication link is occupied; or
the communication apparatus is undergoing a handover process in a target Wi-Fi network, where in a case that the first target communication link is the first communication link, the target Wi-Fi network is the first Wi-Fi network, or in a case that the first target communication link is the second communication link, the target Wi-Fi network is the second Wi-Fi network.

In some embodiments, that the data packet of the target IP address fails to be transmitted over the first target communication link includes that the communication apparatus is undergoing the handover process in the target Wi-Fi network; and
the communication apparatus further includes:
a second processing module, configured to: after the data packet of the target IP address is migrated to the second target communication link for transmission, in a case that it is detected that the communication apparatus is handed over from the target Wi-Fi network to a third Wi-Fi network, and that a third communication link supports use of the first IP address and the first MAC address, map the target IP address back to an original MAC address, and hand over the data packet of the target IP address to the third communication link for transmission, where
the target Wi-Fi network is the first Wi-Fi network, the first target communication link is the first communication link, the target IP address is the first IP address, the original MAC address is the first MAC address, the communication apparatus transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the communication apparatus, and the first Wi-Fi communication interface is a Wi-Fi communication interface connected to the first communication link before the handover; or
the target Wi-Fi network is the second Wi-Fi network, the first target communication link is the second communication link, the target IP address is the second IP address, the original MAC address is the second MAC address, the communication apparatus transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the communication apparatus, and the second Wi-Fi communication interface is a Wi-Fi communication interface connected to the second communication link before the handover.

In some embodiments, the first processing module is configured to:
send a first address mapping packet by using the second target communication link, where the first address mapping packet indicates updating of a mapping relationship between an IP address and a MAC address, so that the target IP address is mapped to the target MAC address.

In some embodiments, the communication apparatus further includes:
a detection module, configured to detect whether the first IP address and the second IP address meet the preset condition after the communication apparatus establishes a connection to each of the first Wi-Fi network and the second Wi-Fi network.

In the communication apparatus 1000 in this embodiment of this application, the first communication module 1001 is configured to communicate with the first Wi-Fi network over the first communication link by using the first IP address and the first MAC address, and communicate with the second Wi-Fi network over the second communication link by using the second IP address and the second MAC address; and the first processing module 1002 is configured to: in the case that the data packet of the target IP address fails to be transmitted over the first target communication link and that the first IP address and the second IP address meet the preset condition, map the target IP address to the target media access control MAC address, and migrate the data packet of the target IP address to the second target communication link for transmission, where the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link. In this way, in the case that the data packet of the target IP address fails to be transmitted over the first target communication link, the communication apparatus migrates data on the first target communication link to the second target communication link for transmission. Therefore, the communication apparatus can maintain continuous uninterrupted data communication, data transmission failure in a period of time due to a network fault, a network handover, or the like can be reduced, and communication efficiency is improved.

The communication apparatus in this embodiment of this application may be an electronic device, or may be a component such as an integrated circuit or a chip in an electronic device. The electronic device may be a terminal, or may be other devices than a terminal. For example, the electronic device may be a mobile phone, a tablet computer, a notebook computer, a palmtop computer, an in-vehicle electronic device, a Mobile Internet Device (MID), an Augmented Reality (AR) or Virtual Reality (VR) device, a robot, a wearable device, an Ultra-Mobile Personal Computer (UMPC), a netbook, a Personal Digital Assistant (PDA), or the like; or the electronic device may be a server, a Network

Attached Storage (NAS), a Personal Computer (PC), a television (TV), a teller machine, a self-service machine, or the like. This is not specifically limited in this embodiment of this application.

The communication apparatus in this embodiment of this application may be an apparatus having an operating system. The operating system may be an Android operating system, an iOS operating system, or other operating systems, and is not specifically limited in this embodiment of this application.

The communication apparatus provided in this embodiment of this application is capable of implementing the processes implemented in the method embodiments in FIG. 3 to FIG. 9. To avoid repetition, details are not described herein again.

As shown in FIG. 11, an embodiment of this application further provides an electronic device 1100, including a processor 1101 and a memory 1102. The memory 1102 stores a program or instructions capable of running on the processor 1101. When the program or instructions are executed by the processor 1101, the steps of the foregoing embodiment of the communication method are implemented, with the same technical effect achieved. To avoid repetition, details are not described herein again.

It should be noted that electronic devices in this embodiment of this application include the foregoing mobile electronic device and a nonmobile electronic device.

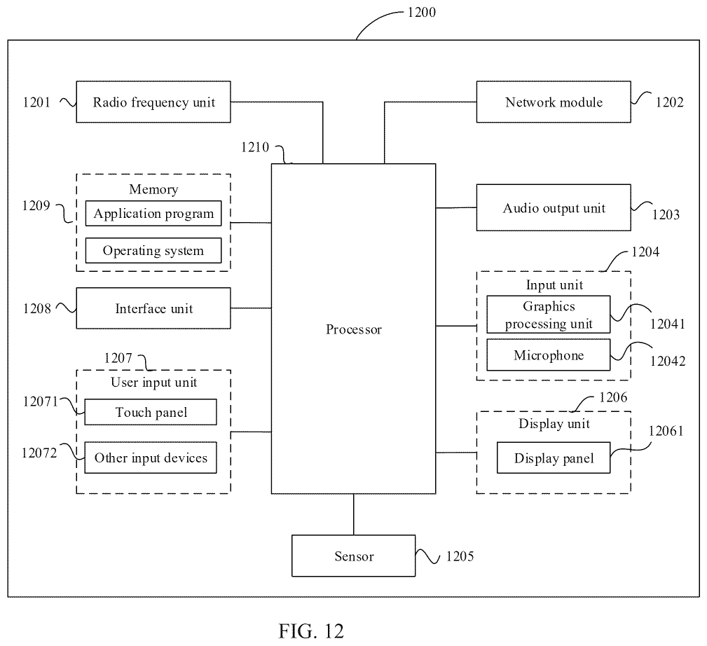

FIG. 12 is a schematic diagram of a hardware structure of an electronic device for implementing an embodiment of this application.

The electronic device 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the electronic device 1200 may further include a power supply (such as a battery) for supplying power to the components. The power supply may be logically connected to the processor 1210 through a power management system. In this way, functions such as charge management, discharge management, and power consumption management are implemented by using the power management system. The structure of the electronic device shown in FIG. 12 does not constitute a limitation on the electronic device. The electronic device may include more or fewer components than those shown in the figure, or some components are combined, or component arrangements are different. Details are not described herein again.

The radio frequency unit 1201 is configured to communicate with a first Wi-Fi network over a first communication link by using a first IP address and a first MAC address, and communicate with a second Wi-Fi network over a second communication link by using a second IP address and a second MAC address; and
the processor 1210 is configured to: in a case that a data packet of a target IP address fails to be transmitted over a first target communication link and that the first IP address and the second IP address meet a preset condition, map the target IP address to a target media access control MAC address, and migrate the data packet of the target IP address to a second target communication link for transmission, where
the first target communication link is the first communication link, the target IP address is the first IP address, the target MAC address is the second MAC address, and the second target communication link is the second communication link; or the first target communication link is the second communication link, the target IP address is the second IP address, the target MAC address is the first MAC address, and the second target communication link is the first communication link.

In some embodiments, the preset condition includes:
the first IP address and the second IP address are located in a same network segment, the target IP address is not used on the second target communication link, and public IP addresses or gateways corresponding to the first IP address and the second IP address are the same.

In some embodiments, that the data packet of the target IP address fails to be transmitted over the first target communication link includes one of the following:
the first target communication link is faulty;
the first target communication link is occupied; or
the communication apparatus is undergoing a handover process in a target Wi-Fi network, where in a case that the first target communication link is the first communication link, the target Wi-Fi network is the first Wi-Fi network, or in a case that the first target communication link is the second communication link, the target Wi-Fi network is the second Wi-Fi network.

In some embodiments, that the data packet of the target IP address fails to be transmitted over the first target communication link includes that the communication apparatus is undergoing the handover process in the target Wi-Fi network; and
the radio frequency unit 1201 is further configured to: after the data packet of the target IP address is migrated to the second target communication link for transmission, in a case that it is detected that the communication apparatus is handed over from the target Wi-Fi network to a third Wi-Fi network, and that a third communication link supports use of the first IP address and the first MAC address, map the target IP address back to an original MAC address, and hand over the data packet of the target IP address to the third communication link for transmission, where
the target Wi-Fi network is the first Wi-Fi network, the target IP address is the first IP address, the original MAC address is the first MAC address, the communication apparatus transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the communication apparatus, and the first Wi-Fi communication interface is a Wi-Fi communication interface connected to the first communication link before the handover; or
the target Wi-Fi network is the second Wi-Fi network, the target IP address is the second IP address, the original MAC address is the second MAC address, the communication apparatus transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the communication apparatus, and the second Wi-Fi communication interface is a Wi-Fi communication interface connected to the second communication link before the handover.

In some embodiments, the radio frequency unit 1201 is configured to send a first address mapping packet by using the second target communication link, where the first address mapping packet indicates updating of a mapping relationship between an IP address and a MAC address, so that the target IP address is mapped to the target MAC address.

In some embodiments, the processor 1210 is further configured to detect whether the first IP address and the second IP address meet the preset condition after the communication apparatus establishes a connection to each of the first Wi-Fi network and the second Wi-Fi network.

In this embodiment of this application, the communication apparatus communicates with the first Wi-Fi network over the first communication link by using the first IP address and the first MAC address, and communicates with the second Wi-Fi network over the second communication link by using the second IP address and the second MAC address; and in the case that the data packet of the target IP address fails to be transmitted over the first target communication link and that the first IP address and the second IP address meet the preset condition, the communication apparatus maps the target IP address to the target media access control MAC address, and migrates the data packet of the target IP address to the second target communication link for transmission. In this way, in the case that the data packet of the target IP address fails to be transmitted over the first target communication link, the communication apparatus migrates data on the first target communication link to the second target communication link for transmission. Therefore, the communication apparatus can maintain continuous uninterrupted data communication, data transmission failure in a period of time due to a network fault, a network handover, or the like can be reduced, and communication efficiency is improved.

It should be understood that, in this embodiment of this application, the input unit 1204 may include a Graphics Processing Unit (GPU) 12041 and a microphone 12042. The graphics processing unit 12041 processes image data of a still picture or video obtained by an image capture apparatus (such as a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or other input devices 12072. The touch panel 12071 is also referred to as a touchscreen. The touch panel 12071 may include two parts: a touch detection apparatus and a touch controller. The other input devices 12072 may include but are not limited to a physical keyboard, a function button (such as a volume control button or a power button), a trackball, a mouse, and a joystick. Details are not described herein again.

The memory 1209 may be configured to store software programs and various data. The memory 1209 may primarily include a first storage area for storing programs or instructions and a second storage area for storing data. The first storage area may store an operating system, an application program or instructions required by at least one function (such as an audio play function and an image play function), and the like. In addition, the memory 1209 may include a volatile memory or a non-volatile memory, or the memory 1209 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data rate SDRAM (DDR SDRAM), an Enhanced SDRAM (ESDRAM), a Synch Link DRAM (SLDRAM), and a Direct Rambus RAM (DRRAM). The memory 1209 in this embodiment of this application includes but is not limited to these and any other suitable types of memories.

The processor 1210 may include one or more processing units. In some embodiments, the processor 1210 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may be not integrated in the processor 1210.

An embodiment of this application further provides a readable storage medium. The readable storage medium stores a program or instructions. When the program or instructions are executed by a processor, each process of the foregoing embodiment of the communication method is implemented, with the same technical effect achieved. To avoid repetition, details are not described herein again.

The processor is a processor in the electronic device in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the communication method, with the same technical effect achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a storage medium, and the program product is executed by at least one processor to implement each process of the foregoing embodiment of the communication method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may be implemented by using hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A communication method, comprising:
communicating, by a communication apparatus, with a first Wireless Fidelity (Wi-Fi) network over a first communication link by using a first Internet Protocol (IP) address and a first Media Access Control (MAC) address, and communicating with a second Wi-Fi network over a second communication link by using a second IP address and a second MAC address; and
when a data packet of a target IP address fails to be transmitted over a first target communication link and that the first IP address and the second IP address meet a preset condition, mapping the target IP address to a target MAC address, and migrating the data packet of the target IP address to a second target communication link for transmission, wherein:
the first target communication link is the first communication link, the target IP address is the first IP address, the target MAC address is the second MAC address, and the second target communication link is the second communication link; or
the first target communication link is the second communication link, the target IP address is the second IP address, the target MAC address is the first MAC address, and the second target communication link is the first communication link.

2. The communication method according to claim 1, wherein the preset condition comprises:
the first IP address and the second IP address are located in a same network segment, the target IP address is not used on the second target communication link, and public IP addresses or gateways corresponding to the first IP address and the second IP address are the same.

3. The communication method according to claim 1, wherein that the data packet of the target IP address fails to be transmitted over the first target communication link comprises one of the following:
the first target communication link is faulty;
the first target communication link is occupied; or
the communication apparatus is undergoing a handover process in a target Wi-Fi network, wherein when the first target communication link is the first communication link, the target Wi-Fi network is the first Wi-Fi network, or when the first target communication link is the second communication link, the target Wi-Fi network is the second Wi-Fi network.

4. The communication method according to claim 3, wherein that the data packet of the target IP address fails to be transmitted over the first target communication link comprises that the communication apparatus is undergoing the handover process in the target Wi-Fi network; and
after the migrating the data packet of the target IP address to a second target communication link for transmission, the communication method further comprises:
when it is detected that the communication apparatus is handed over from the target Wi-Fi network to a third Wi-Fi network, and that a third communication link supports use of the first IP address and the first MAC address, mapping the target IP address back to an original MAC address, and handing over the data packet of the target IP address to the third communication link for transmission, wherein:
the target Wi-Fi network is the first Wi-Fi network, the target IP address is the first IP address, the original MAC address is the first MAC address, the communication apparatus transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the communication apparatus, and the first Wi-Fi communication interface is a Wi-Fi communication interface connected to the first communication link before the handover; or
the target Wi-Fi network is the second Wi-Fi network, the target IP address is the second IP address, the original MAC address is the second MAC address, the communication apparatus transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the communication apparatus, and the second Wi-Fi communication interface is a Wi-Fi communication interface connected to the second communication link before the handover.

5. The communication method according to claim 1, wherein the mapping the target IP address to a target MAC address comprises:
sending a first address mapping packet by using the second target communication link, wherein the first address mapping packet indicates updating of a mapping relationship between an IP address and a MAC address, so that the target IP address is mapped to the target MAC address.

6. The communication method according to claim 1, wherein before the mapping the target IP address to a target MAC address, the communication method further comprises:
after the communication apparatus establishes a connection to each of the first Wi-Fi network and the second Wi-Fi network, detecting whether the first IP address and the second IP address meet the preset condition.

7. An electronic device, comprising a processor and a memory storing a program or instructions capable of running on the processor, wherein the program or the instructions, when executed by the processor, causes the electronic device to perform operations comprising:
communicating with a first Wireless Fidelity (Wi-Fi) network over a first communication link by using a first Internet Protocol (IP) address and a first Media Access Control (MAC) address, and communicating with a second Wi-Fi network over a second communication link by using a second IP address and a second MAC address; and
when a data packet of a target IP address fails to be transmitted over a first target communication link and that the first IP address and the second IP address meet a preset condition, mapping the target IP address to a target MAC address, and migrating the data packet of the target IP address to a second target communication link for transmission, wherein:
the first target communication link is the first communication link, the target IP address is the first IP address, the target MAC address is the second MAC address, and the second target communication link is the second communication link; or
the first target communication link is the second communication link, the target IP address is the second IP address, the target MAC address is the first MAC address, and the second target communication link is the first communication link.

8. The electronic device according to claim 7, wherein the preset condition comprises:
the first IP address and the second IP address are located in a same network segment, the target IP address is not used on the second target communication link, and public IP addresses or gateways corresponding to the first IP address and the second IP address are the same.

9. The electronic device according to claim 7, wherein that the data packet of the target IP address fails to be transmitted over the first target communication link comprises one of the following:
the first target communication link is faulty;
the first target communication link is occupied; or
the electronic device is undergoing a handover process in a target Wi-Fi network, wherein when the first target communication link is the first communication link, the target Wi-Fi network is the first Wi-Fi network, or when the first target communication link is the second communication link, the target Wi-Fi network is the second Wi-Fi network.

10. The electronic device according to claim 9, wherein that the data packet of the target IP address fails to be transmitted over the first target communication link comprises that the electronic device is undergoing the handover process in the target Wi-Fi network; and
after the migrating the data packet of the target IP address to a second target communication link for transmission, the operations further comprise:
when it is detected that the electronic device is handed over from the target Wi-Fi network to a third Wi-Fi network, and that a third communication link supports use of the first IP address and the first MAC address, mapping the target IP address back to an original MAC address, and handing over the data packet of the target IP address to the third communication link for transmission, wherein:
the target Wi-Fi network is the first Wi-Fi network, the target IP address is the first IP address, the original MAC address is the first MAC address, the electronic device transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the electronic device, and the first Wi-Fi communication interface is a Wi-Fi communication interface connected to the first communication link before the handover; or
the target Wi-Fi network is the second Wi-Fi network, the target IP address is the second IP address, the original MAC address is the second MAC address, the electronic device transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the electronic device, and the second Wi-Fi communication interface is a Wi-Fi communication interface connected to the second communication link before the handover.

11. The electronic device according to claim 7, wherein the mapping the target IP address to a target MAC address comprises:
sending a first address mapping packet by using the second target communication link, wherein the first address mapping packet indicates updating of a mapping relationship between an IP address and a MAC address, so that the target IP address is mapped to the target MAC address.

12. The electronic device according to claim 7, wherein before the mapping the target IP address to a target MAC address, the operations further comprise:
after the electronic device establishes a connection to each of the first Wi-Fi network and the second Wi-Fi network, detecting whether the first IP address and the second IP address meet the preset condition.

13. A non-transitory computer-readable storage medium storing a program or an instruction, wherein the program or the instruction, when executed by a processor, causes the processor to perform operations comprising:
communicating, by a communication apparatus, with a first Wireless Fidelity (Wi-Fi) network over a first communication link by using a first Internet Protocol (IP) address and a first Media Access Control (MAC) address, and communicating with a second Wi-Fi network over a second communication link by using a second IP address and a second MAC address; and
when a data packet of a target IP address fails to be transmitted over a first target communication link and that the first IP address and the second IP address meet a preset condition, mapping the target IP address to a target MAC address, and migrating the data packet of the target IP address to a second target communication link for transmission, wherein:
the first target communication link is the first communication link, the target IP address is the first IP address, the target MAC address is the second MAC address, and the second target communication link is the second communication link; or
the first target communication link is the second communication link, the target IP address is the second IP address, the target MAC address is the first MAC address, and the second target communication link is the first communication link.

14. The non-transitory computer-readable storage medium according to claim 13, wherein the preset condition comprises:
the first IP address and the second IP address are located in a same network segment, the target IP address is not used on the second target communication link, and public IP addresses or gateways corresponding to the first IP address and the second IP address are the same.

15. The non-transitory computer-readable storage medium according to claim 13, wherein that the data packet of the target IP address fails to be transmitted over the first target communication link comprises one of the following:
the first target communication link is faulty;
the first target communication link is occupied; or
the communication apparatus is undergoing a handover process in a target Wi-Fi network, wherein when the first target communication link is the first communication link, the target Wi-Fi network is the first Wi-Fi network, or when the first target communication link is the second communication link, the target Wi-Fi network is the second Wi-Fi network.

16. The non-transitory computer-readable storage medium according to claim 15, wherein that the data packet of the target IP address fails to be transmitted over the first target communication link comprises that the communication apparatus is undergoing the handover process in the target Wi-Fi network; and
after the migrating the data packet of the target IP address to a second target communication link for transmission, the operations further comprise:
when it is detected that the communication apparatus is handed over from the target Wi-Fi network to a third Wi-Fi network, and that a third communication link supports use of the first IP address and the first MAC address, mapping the target IP address back to an original MAC address, and handing over the data packet of the target IP address to the third communication link for transmission, wherein:
the target Wi-Fi network is the first Wi-Fi network, the target IP address is the first IP address, the original MAC address is the first MAC address, the communication apparatus transitions from communicating with the first Wi-Fi network over the first communication link by using the first IP address and the first MAC address to communicating with the third Wi-Fi network over the third communication link by using the first IP address and the first MAC address, one end of the third communication link is connected to a first Wi-Fi communication interface of the communication apparatus, and the first Wi-Fi communication interface is a Wi-Fi communication interface connected to the first communication link before the handover; or
the target Wi-Fi network is the second Wi-Fi network, the target IP address is the second IP address, the original MAC address is the second MAC address, the communication apparatus transitions from communicating with the second Wi-Fi network over the second communication link by using the second IP address and the second MAC address to communicating with the third Wi-Fi network over the third communication link by using the second IP address and the second MAC address, the third communication link is connected to a second Wi-Fi communication interface of the communication apparatus, and the second Wi-Fi communication interface is a Wi-Fi communication interface connected to the second communication link before the handover.

17. The non-transitory computer-readable storage medium according to claim 13, wherein the mapping the target IP address to a target MAC address comprises:
sending a first address mapping packet by using the second target communication link, wherein the first address mapping packet indicates updating of a mapping relationship between an IP address and a MAC address, so that the target IP address is mapped to the target MAC address.

18. The non-transitory computer-readable storage medium according to claim 13, wherein before the mapping the target IP address to a target MAC address, the operations further comprise:
after the communication apparatus establishes a connection to each of the first Wi-Fi network and the second Wi-Fi network, detecting whether the first IP address and the second IP address meet the preset condition.
